(19) United States
(12) Patent Application Publication
(10) Pub. No.: US 2022/0334047 A1
(43) Pub. Date: Oct. 20, 2022

(54) METHOD AND DEVICE FOR DETERMINING FEATURES OF PARTICLES BY MULTIPARAMETRIC CAPTURE OF SCATTERED LIGHT AND EXTINCTION SIGNALS

(71) Applicant: LUM GMBH, Berlin (DE)

(72) Inventors: Dietmar LERCHE, Berlin (DE); Heinz LICHTENFELD, Berlin (DE); Martin HUSSELS, Berlin (DE); Holger WOEHLECKE, Berlin (DE); Elia WOLLIK, Berlin (DE); Martin HOLKE, Berlin (DE); Marcus WOLFF, Niedergörsdorf (DE); Uwe MERTENS, Bestensee (DE)

(21) Appl. No.: 17/810,437

(22) Filed: Jul. 1, 2022

Related U.S. Application Data
(63) Continuation of application No. PCT/EP2021/050028, filed on Jan. 4, 2021.

(30) Foreign Application Priority Data
Jan. 2, 2020 (DE) 10 2020 100 020.0

(51) Int. Cl. G01N 15/14

(52) U.S. Cl. CPC G01N 15/1429; G01N 15/1459; G01N 15/1434; G01N 2015/1006

(57) ABSTRACT

Disclosed are a method and a device for determining characteristics of particles dispersed in gases and liquids in the nano- and microscale size ranges and the number distribution and concentration thereof by use of particle photometry. This can be achieved by producing scattered light measurements in a photometer for a different number of aperture or receiving angles and evaluating particle characteristics from the determined scattered light intensities using evaluation algorithms. The determination of particle characteristics over a size range of several decades is made possible without the need to change or adapt the geometry of the sample measurement chamber.

This application is a continuation of International Application No. PCT/EP2021/050028, filed Jan. 4, 2021, which claims the benefit of priority to German Application No. 10 2020 100 020.0, filed Jan. 2, 2020, each of which is incorporated by reference herein in its entirety.

### TECHNICAL FIELD

The invention relates to a method and a device for determining characteristics of particles dispersed in gases or liquids in the nano- and microscale size range and the number distribution and concentration thereof by use of particle photometry.

### BACKGROUND

Numerous methods exist for determining the size of colloidal particles (such as nanoparticles, emulsion droplets) or coarsely dispersed particles.

Known optical methods are, for example, static and dynamic scattered light measurements (ISO 13320, ISO 22412) and gravitation-based or centrifugation-based (ISO 13317-1, ISO 13318-2) sedimentation methods. The examinations of suspensions and emulsions with volume scattered light methods or sedimentation methods have in common that the determined particle parameters generally refer to the superimposed scattering behaviour of all particles located in the geometric measuring volume (particle ensemble). The resulting scattered light intensity or the extinction depends on the particle concentration and the optical particle properties (size, geometry and refractive index contrast). Mathematical methods are used to obtain a particle size distribution from the superimposed measurement signals. Irrespective of the algorithms used, these methods are always intensity-based or extinction-based and, to allow a comparison with imaging methods, can only be transformed into a volume-weighted or number-weighted distribution by conversion, e.g. using Mie theory, if the optical properties of the particles are known (assuming identical refractive index and spherical shape). The drawback is that the physics of these methods in principle do not allow for information relating to individual particle features. The interaction of acoustic waves and X-ray waves with particles is also used to determine particle size. These methods also provide only averaged ensemble values and do not provide number-weighted distributions and characteristics of individual particles. It should also be noted that the scattering methods described so far do not allow access to the concentration of particles of individual size classes for polydisperse suspensions and emulsions.

Various measurement methods seeking to determine number-weighted particle size distributions are also described in the literature. The first of note are optical methods which capture the particles statically or dynamically using imaging methods and determine the size of each imaged particle manually or using computer-assisted image evaluation methods. Static transmission or electron microscopy methods and, more recently, force-microscopic methods are conventionally used for sub-microscale and nanoscale particles.

In any case, volume-based particle size distributions can only be calculated on the basis of 2D images in which assumptions are made about the 3D shape. Moreover, for broad distributions, images at different image magnifications are necessary, which makes it much more difficult to perform calibrations and to calculate cumulative distributions and de facto does not allow concentration to be determined. The methods are also very time-consuming. Furthermore, the described methods can only be used for dry particles (powders). Dynamic imaging techniques (e.g. Flow Cam, Bettersizer, CAMSIZER, QICPIC) are characterized by better statistics. However, dynamic methods are limited to particles larger than 800 nm [ISO 13322].

The measuring principle of flow cytometers is single particle scattered light photometry. The prior art has not disclosed any related subject matter disclosed which, for example, allows the experimental simultaneous determination of the particle size and refractive index of nanoparticles and microparticles. The analysis of particle size for microscale particles is not always possible due to the ambiguities of the intensity curve of the scattered light from the particle diameter (cf. e.g. FIG. 7), and solutions for this problem have not yet been disclosed. Experimental experience also shows that, in the described assemblies, in particular for particles with large particle masses due to geometric size or density, the number of particles may be significantly underestimated, in particular for the larger classes (segregation). However, it should also be noted that, conversely, the superposition of scattered light with very different intensities as a result of significantly different particle sizes leads to the smaller particles being underestimated. This may also be independent of size for particles with very different refractive indices or particle fractions with a very small refractive index contrast.

A publication EP 2908119 B1 is also known, which deals with a “method for detecting nano-particles” based on a flow principle. The measurement range for small particles (preferably <100 nm) is supposed to be extended by reducing the detection zone. The measurements are carried out for only one angle in sideways scattering. The publication describes a method that shifts the typical measurement range of flow cytometry into the nano range and is in principle not applicable to microscale particles.

The publication EP 2388569 A1 discloses a method and an apparatus having two sensors, which operate according to physically different measurement methods, for determining the size and number of particles dispersed in liquids, this method being referred to as single particle optical sensing (SPOS). The major metrological difference to the principle of a flow cytometer is that different physical measurement principles are used to analyze broadly distributed particle sizes (scattering sensor and extinction sensor) and, due to the method, the measuring chamber depth is greatly minimised, and the laser beam has a small focus diameter with a Gaussian intensity distribution over the cross section.

Simultaneous assessment of the extinction and scattering for the same particle is not disclosed in this publication and, from a technical point of view, is not possible with the proposed implementation principle.

Simultaneous determination of multiple particle features (e.g. size, refractive index, geometry) for all individual particles in the measurement sample is not disclosed.

Particle tracking analysis (ISO 19430:2016), which has been established on the market in recent years, measures the temporal displacement of nanoparticles and sub-scale particles by means of laser-induced scattered light and calculates the particle size from the square of the mean distance per unit of time according to Einstein and Smoluchowski. Drawbacks of this method that have yet to be remedied are the dependence of the detection sensitivity on physical size, which leads to losses in the determination of the number of particles as well as a distortion of the particle distribution, in particular in the fine grain fraction. Another shortcoming is the determination of the active measurement volume, which depends on the size and/or the refractive index of the dispersed particles. Determining particle concentration in polydisperse samples is therefore always prone to error.

This technique can also only be used for particles dispersed in liquids.

All the above principles and measurement devices have in common that they cannot simultaneously determine multiple features (e.g. size, refractive index, geometry, number, concentration) of particles dispersed in air or liquids, i.e. in a suspension, emulsion or aerosol.

For the sake of completeness, it should be mentioned that several documents have been published in which the simultaneous determination of size and refractive index of particles in dispersions are described for special cases, but they differ from the claimed invention in terms of methodology and also have a number of limitations. The publication WO 2017/072360 A1 is supposed preferably to apply to particles which are smaller than the wavelength of the radiated light (preferred wavelength 405 nm or 488 nm). However, this measurement range is said to be able to be extended to up to three times the wavelength. The optical scatter ratio (forward scattering/side scattering) is said to be independent of the refractive index in this range. From this, the size can be determined, and according to the theory, the refractive index can be determined from one of the two scattered light measurements.

A published table with experimental results only documents results for particles which are all smaller than the radiated wavelength (405 nm). Only measurements with PS and SiO2 particles were given, with the error indications for the measurements all being greater than those of the manufacturer's indications.

Our own theoretical calculations confirm the larger error range; the method fails when the intensity oscillations already mentioned above fall in the reception angle ranges. Therefore, an extension of this method to particle sizes >wavelength of the radiated light will generally not be possible.

A very complex measurement method according to US patent specification 9,068,915 B2 determines the refractive index of a particle type by comparing the forward and side scattering of two samples. A prerequisite for the application of this method is that, firstly, the two samples have different particle sizes and, secondly, the particle size and the refractive index of a sample (batch) must be known. Alternatively, the refractive index of particles can be determined with this method if their size is known, which therefore rules out the simultaneous determination of size and refractive index.

This document does not disclose how to proceed in the case of polydisperse distributions.

All solutions known in the prior art are based on measurement principles that differ substantially from the subject matter of the disclosed invention and have substantial limitations and drawbacks, in particular for broadly distributed particle samples in the nanoscale or sub-microscale and microscale size range, in comparison with the claimed inventive solution.

### SUMMARY

The invention relates to a method and a device for determining characteristics of particles dispersed in gases or liquids in the nano- and microscale size range and the number distribution and concentration thereof by use of particle photometry. According to the invention, this is achieved by taking scattered light measurements of fractions or individual particles in a photometer for a different number of aperture or receiving angles, counting the particles, determining characteristic features (e.g. size, refractive index) for each particle from the determined scattered light intensities using evaluation algorithms, and classifying the entirety of the particles contained in the measurement sample accordingly. The determination of the particle features over a size range of more than two decades is made possible without the need to change or adapt the geometry of the sample measurement chamber or optics.

Suspensions (e.g. polymer and oxide particles dispersed in aqueous media, but also biological materials) or emulsions (e.g. nutritional infusions) occur in many areas of nature, medicine, industry, research and in private households and/play an extremely important role in these areas. Unwanted particles in production operations, contaminating particles in waste water or the particle load (e.g. microplastics) in natural waters also require suitable purification measures (e.g. drinking water treatment, air purification).

The quantitative determination of particle characteristics, such as size, number, concentration or their optical properties is of great importance from scientific, product-related or risk-related points of view (e.g. nanomaterial classification). These requirements occur in particular in the field of modern particle technology for nanoparticles and microscale particles dispersed in gases or liquids. Moreover, in order to better understand and influence the dispersion properties or to formulate relevant products, it is essential to know not only the chemical composition of the dispersed phase, but also the size (particle size distribution (PSD)), number (concentration) or optical properties, such as shape and refractive index of the particles.

Known measurement methods in the claimed PSD range, examples of which are mentioned in the “Prior art” section, have a range of drawbacks. For example, established reference methods (microscopy or electron microscopy) are very time-consuming, and for dispersed, highly polydisperse particle systems, there are experimental and metrological difficulties that prohibit their widespread use, in particular in industry. Moreover, the widely used static and dynamic light scattering methods (ISO 13320, ISO 22412) are ensemble methods. The physical measurement principles do not allow any information about individual particles, and the measured scattering intensity is a particle dependent on its size, the geometry and the refractive index contrast as well as the optical characteristics of the measurement instruments; moreover, above a certain particle size, said measured scattering intensity is no longer a one-to-one function of the particle size.

An object of the invention is therefore that of: determining multiple particle characteristics, such as particle concentration, size distribution and number of particles per size class, for each individual liquid-borne or gas-borne individual particle in a suspension, emulsion or an aerosol, both for particles distributed narrowly and over several orders of magnitude, with the aid of scattered light measurements dependent on spatial angles; and quantifying additional particle characteristics, such as refractive index or asphericity, from the measurement signals from the individual particles using evaluation algorithms. The invention also focuses on narrow size classes of a few nanometres. A further object to be achieved is, in the case of implementation as a single-particle scattered light photometer, to allow a detection rate (events/s, often also referred to as frequency) of the scattered light events of, for example, at least 10,000 events per second and to control this detection rate automatically by hydrodynamic or aerodynamic means alone in order to achieve, in comparison with the prior art (e.g. EP 2388569 A1), a very high and high concentration range concentration range, e.g. from 10² to 10⁹ particles/ml, of the primary measurement sample, to detect the particle features for each particle without coincidence-induced distortion and dilution of the primary sample, preferably to analyze said particle features in real time, to classify said particle features accordingly, and to achieve this without having to replace measurement chambers or make geometric changes to the measurement cell.

Expedient embodiments of the invention are included in the dependent claims.

A particular advantage of the method according to the invention is that of an effective determination of particle features in which, in order to determine the properties of microscale and sub-microscale particles down to the single-digit nano range in measurement samples by multiparametric detection of extinction and/or scattered light signals, the scattered light signals and the extinction signals of the particles are counted in at least two spatial angle ranges with large detection rates events/s, simultaneously measured, and compared in an analogue or digital manner with simulation calculations of the scattered light distribution by analytical or numerical methods for the different spatial angle ranges in order to determine particle characteristics therefrom over a wide dynamic particle size range, even for high particle concentrations of the measurement samples.

Detection rates within the meaning of this invention mean counting events in the range of less than 10 particles up to one million particles per second, in particular from 100 to 10,000 particles per second with a pulse height above the noise signals. At particle concentrations of preferably 10¹⁰ particles per ml, the number of particles is measured largely without coincidence. For detection rates of, for example, 10 kHz, counting losses of less than 0.0035 (0.35%) occur. In other words, the inventive solution measures de facto all particles of the sample stream and is characterized by an extremely high sensor sensitivity in comparison with the prior art. In EP 2338569 A1 (e.g. FIG. 9), effectiveness factors of only a few percent to a tenth of a percent are given, which depend on the particle size.

Further advantages of the invention result from the fact that different aperture angles can be used for the forward scattering, or multiple detection directions can be used for the scattered light measurement, and any combinations of these can be used.

In the case of particles with size parameters k greater than or approximately equal to 20, for example, different aperture angles are used for forward scattering.

An additional advantage of the invention results from the fact that, in the case of particles with hardly distinguishable forward scattered light curves in the different reception angles (in particular in the case a size parameter k smaller than or approximately equal to 20), multiple detection directions are used in sideways directions with different sensitivities.

According to the invention, a simulation calculation is carried out by use of Mie theory or numerical calculations in accordance with the corresponding optical set-up, and any ambiguity regarding the particle size is removed from the comparison between theory and experimental scattering intensity. This means that even microscale particles, typically up to 100 μm, can be analyzed.

According to the invention, particle properties, such as size or optical particle parameters, are determined by consistency testing of the modelled and experimentally determined intensities of the particle pulses for different aperture angles and/or spatial angle ranges.

If the scattered light intensities measured in the angular ranges do not correspond to the possible theoretical intensities, asphericity is concluded and an asphericity index is calculated if, for example, the size and refractive index of the particles are known.

A further advantage of the invention is that, in the case of single-particle scattering, the shape of the particle is classified as spherical or aspherical from the comparison of the experimental, digitised pulse shape of a particle with a known refractive index and the corresponding simulation calculations for spherical particles for the same spatial angle range.

Quantitative results are obtained using theories that deal with the relationship between the geometry of a particle (asphericity) and the scattering behaviour.

The invention makes it possible to analyze all particles present in the sample, apart from particle wall adhesions or separation phenomena, and to classify cumulative distributions or sub-fractions of the particles according to size, shape and refractive index, for example. The numbers of particles (concentrations) per feature unit are determined, displayed and outputted in absolute terms.

A laser is used with variable beam intensity and an aspherical beam cross section (focus) with constant light intensity at least over the cross section of the sample stream (16, FIG. 1b). This means that the scattering pulse, in contrast with that described in the prior art (SPOS), is not dependent on the trajectory of the measured particle in the measurement volume, and deconvolution is not necessary. In the case of insufficient uniformity of the intensity, this is corrected by normalisation methods (e.g. experimental determination of the deviation from a constant intensity or by measuring size-certified monodisperse reference particles). To extend the measurement range, lasers with different wavelengths or multiple lasers including fluorescence can also be used.

The extent of the hydrodynamic or aerodynamic measurement flow focusing can be adjusted manually or automatically by the ratio of the sheath flow to the sample flow, depending on the initial number concentration of the measurement sample, based on knowledge or an initial measurement cycle.

Another advantage of the invention is that, in order to determine size in very broad polydisperse samples, it is not necessary to swap measurement chambers or to make changes, e.g. to the geometry of the flowcell and the optical set-up. For extremely wide distributions up to the multi-digit micrometre size range, the measurement of different scattering angles or the simultaneous recording of the extinction of the individual particles can be used.

Additionally advantageous is the possibility of beam stops being able to be inserted or moved one after the other, or using ring-shaped, rotatable detectors that each cover an angle range, or introducing different apertures in circular sectors. Optical elements with special coatings can also be used, the transparency of which can be varied for the particular laser wavelength in use by use of e.g. electrical fields without mechanical displacement.

By using ring-shaped detectors or different apertures in circular sectors, the repeated measurements in other angle ranges described in the examples are no longer necessary, which advantageously reduces the experimental effort and increases the measurement accuracy by simultaneously measuring different angle ranges for the same particle.

For extinction applications using hydrodynamic focusing and by masking out the areas illuminated by the primary radiation in the image space that are adjacent to the hydrodynamically focused particles, the ratio of the light intensity of the light source in the cuvette to an extinction signal is improved to detect smaller particles.

By use of a pinhole which is inserted after the objective and has the diameter of the primary laser beam after the objective, a large part of the forward scattering, which would also strike the receiver, is eliminated, thus extending the measurement range to smaller particles and allowing more accurate calculations of the particle size. With reference to the publication EP 2 388 59 A1, it is advantageous that, due to the isolation of the particles, the transmission in the regions between the particles does not have any turbidity, which dependent on particle concentration.

According to the invention, the device and the method are used for the analysis of multiple features of individual particles and for the classification or identification of particle fractions in the industrial and academic field, such as W/O or O/W emulsions, aerosols, slurries for wafer polishing, ink and pigment suspensions, samples of cellular and sub-cellular particles (including cells, viruses, bacteria) of biological origin or for applications such as the design of nanoparticles, quantification of the stability of dispersions, investigations into the dissolution, agglomeration and flocculation behaviour of disperse phases, quantification of the progress of dispersions.

The invention will be explained in more detail below on the basis of embodiments shown at least in part in the drawings.

### BRIEF DESCRIPTION OF THE DRAWINGS

In the drawings:

FIG. 1 shows extinction of some organic substances (n=1.43); λ=532 nm; x=particle diameter [μm]; y=scattering cross section [arbitrary units].

FIG. 1a shows basic optical principle of the measure method.

FIG. 1b shows geometry in the sample chamber.

FIG. 2a shows hydrodynamic focusing.

FIG. 2b shows flow cell.

FIG. 3a is an electronic diagram and data flows within the instrument and the external software SepView.

FIG. 3b shows electronic components for operation and data processing.

FIG. 4 shows an analogue individual pulse of a particle and exemplary characteristic quantitative features for the pulse shape for a possible pulse discrimination as a basis for a manual or automatic classification of particle features.

FIG. 4a shows measurement results for simultaneous scattered light detection in the forward (left) and sideways (right) directions of a mixture of polystyrene particles of different sizes.

FIG. 5 shows concentration determination for polystyrene particles and count rates for polystyrene microparticles and gold nanoparticles.

FIG. 6 shows a basic sequence of a typical analysis flow for the calculation of the particle size distribution.

FIG. 7 shows scattered light curve of polystyrene particles; n=1.59; reception angle range: 4°-12.33°; λ=532 nm; x=particle diameter [μm]; y=Mie scattered light intensity [arbitrary units].

FIG. 8 shows scattered light curve of polystyrene particles (different reception angle ranges); λ=532 nm; n=1.59; a: 4°-12.33°; b: 5°-12.33°; c: 6°-12.33°; d: 8°-12.33°; x=particle diameter [μm]; y=Mie scattered light intensity [arbitrary units].

FIG. 9 shows scattered light curve of particles with an assumed refractive index of n=1.8; (different reception angle ranges) λ=532 nm; a: 4°-12.33°; b: 5°-12.33°; c: 6°-12.33°; d: 8°-12.33°; x=particle diameter [μm]; y=Mie scattered light intensity [arbitrary units].

FIG. 10 shows scattered light curve of silicon dioxide with an assumed refractive index of n=1.46 (different reception angle ranges); Aλ=532 nm; a: 4°-12.33°; b: 5°-12.33°; c: 6°-12.33°; d: 8°-12.33°; x=particle diameter [μm]; y=Mie scattered light intensity [arbitrary units].

FIG. 11 shows Scattered light curve of silicon dioxide with an assumed refractive index of n=1.47 (different reception angle ranges); λ=532 nm; a: 4°-12.33°; b: 5°-12.33°; c: 6°-12.33°; d: 8°-12.33°; x=particle diameter [μm]; y=Mie scattered light intensity [arbitrary units].

FIG. 12 shows Scattered light curve of silicon dioxide with an assumed refractive index n=1.46; selected particle diameters (different reception angle ranges); A=532 nm; a: 4°-12.33°; b: 5°-12.33°; c: 6°-12.33°; d: 8°-12.33°; x=particle diameter [μm]; y=Mie scattered light intensity [arbitrary units].

FIG. 13 shows Scattered light curve of silicon dioxide with an assumed refractive index of n=1.47; selected particle diameters (different reception angle ranges); A=532 nm; a: 4°-12.33°; b: 5°-12.33°; c: 6°-12.33°; d: 8°-12.33°; x=particle diameter [μm]; y =Mie scattered light intensity [arbitrary units].

FIG. 14 shows Scattered light curve of silicon dioxide (sideways scattering) with an assumed refractive index of a: n=1.47 and b: n=1.46; selected particle diameter range; λ=532 nm; half aperture angle: 10.02°; x=particle diameter [μm]; y=Mie scattered light intensity [arbitrary units].

FIG. 15 shows Scattered light curve of silicon dioxide (sideways scattering) with an assumed refractive index of a: n=1.46 and b: n=1.47; selected particle diameter range; λ=532 nm; half aperture angle: 10.02°; x=particle diameter [μm]; y=Mie scattered light intensity [arbitrary units].

FIG. 16 shows 2D plot: Refractive index as a function of particle size; n=refractive index; x=particle size.

FIG. 17 shows 2D plot: Sphericity as a function of refractive index; Al=asphericity index; n=refractive index.

FIG. 18 shows Scattered light intensities (sideways scattering) of silicon dioxide particles dispersed in air a: n=1.0 and in water b: n=1.335; aperture angle: 10.02°; x=particle diameter [μm]; y=Mie scattered light intensity [arbitrary units].

FIG. 19 shows Basic sketch of the measurement zone together with particles, as seen in the direction of the laser beam; the direction of flow of the particles is indicated by the arrow, a) volume scattered light device; b) single-particle scattered light photometer with laser focusing and shaping without—and c) with hydrodynamic focusing.

FIG. 20 shows Blocking of scattered light radiation by an aperture (dark grey circle); laser primary beam with extinction signals (light grey circle) is transmitted through the pinhole.

FIG. 21 shows Extinction measurement of a 552 nm polystyrene latex (with background correction); X=number of channels on the multichannel analyzer; Y=extinction [arbitrary units].

FIG. 22 shows Extinction of a mixture of polystyrene (PS) and melamine resin (MF) particles of different sizes; a: 0.815 μm PS; b: 1.05 μm PS; c: 1.3 μm MF; X=number of channels on the multichannel analyzer; Y=extinction [arbitrary units].

### DETAILED DESCRIPTION

### 1. Measurement Apparatus of the Single-particle Photometer

The technical realisation of the invention will be explained below by way of example.

### Optical Measurement Set-up

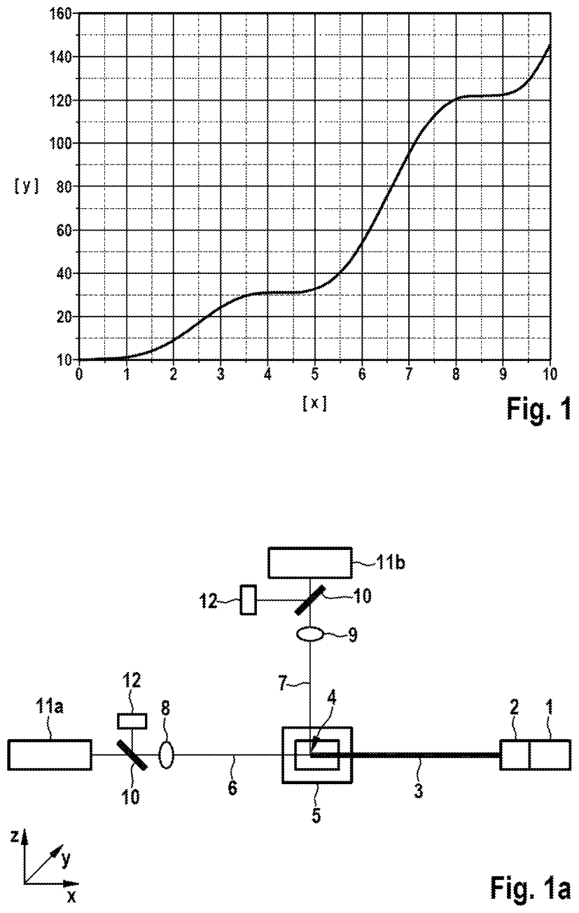

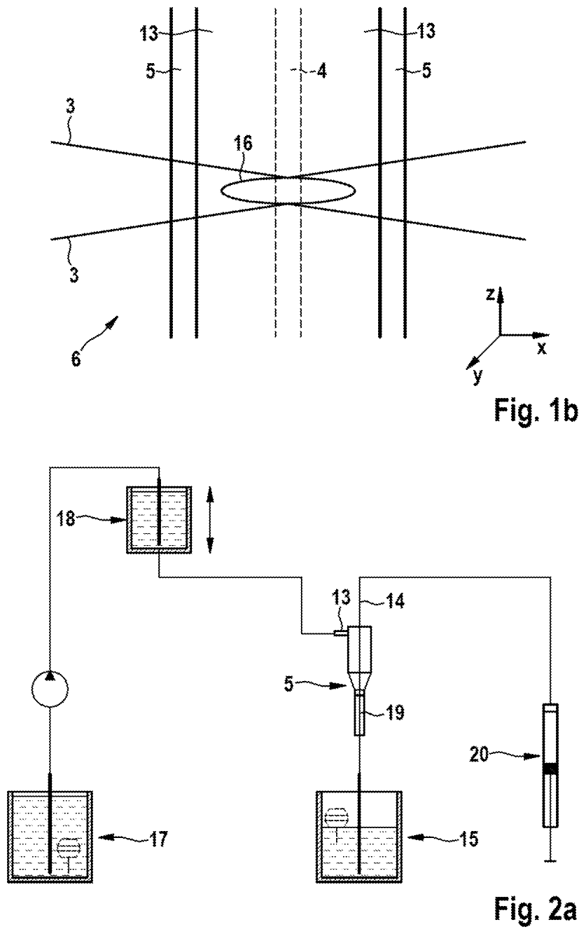

FIG. 1a shows a typical set-up of the measuring apparatus with a focus on the optics in plan view (z direction). The device according to the invention comprises at least one laser 1 for generating at least one laser beam 3, at least one optical input module 2, e.g. for shaping the laser beam 3 and forming a focus geometry 16 (FIG. 1b) or similar), a flow cell 5, advantageously with hydrodynamic focusing, in which forward scattered light radiation 6 and sideways scattered light radiation 7 are generated by the laser beam 3, optical output modules 8 in the forward scattered light beam 6 and optical output modules 9 in the sideward scattered light beam 7, semi-transparent mirrors 10, cameras 12, photomultipliers 11a, 11b, wherein scattered light measurements are carried out for a different number of aperture or reception angles by use of the photomultipliers 11a, 11b, and particle features are determined from the determined scattered light intensities of the forward scattered light beam 6 and the sideways scattered light beam 7 using evaluation algorithms.

The light source 1 is ideally a stable monochromatic, intensity-controllable and short-wave laser with a power of e.g. 100 mW. Other light sources and designs can also be used. According to the invention, all wavelengths in the visible and near UV and IR range can be used. The smaller the wavelengths, the smaller the particles that can be measured. The coupling of different or several lasers is also possible via the optical module 2 or by use of corresponding optical components via the light beam 3. The optical module 2 is used to form an e.g. elliptical focus geometry (16 in FIG. 1b), which takes into account both an equal light intensity in the measurement volume and a low coincidence of the particles. Both use can also be integrated in one module. The incident and scattered beams can also be “guided” by light guides, which is useful, for example, with regard to the miniaturisation of the set-up. The use of micro-optical components is particularly advantageous. The incident light beam 3 is focused on the single-particle flow 4 in the flow cell 5.

It should be noted that relevant components of the primary radiation do not strike the edges of the measurement in order to minimise background radiation.

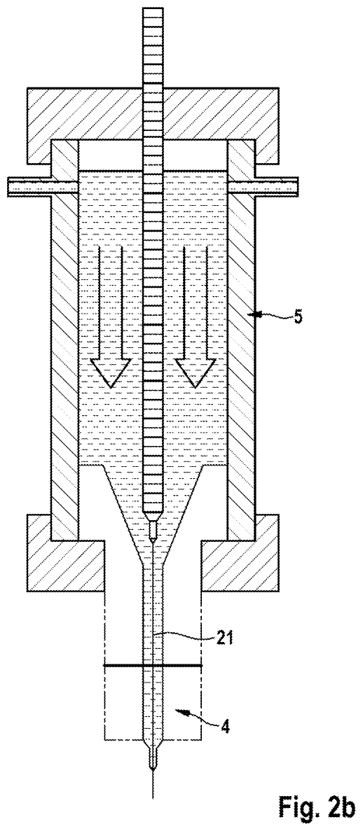

FIG. 1b shows the situation as a section viewed from the sideways scattering 7 (y-direction). The focus geometry is intended typically to be selected so that the width (x) thereof is greater than the diameter of the particle flow. This can be achieved, for example, by a combination of appropriate lenses in the module 2 and/or the use of apertures. Furthermore, the focus is formed by use of the optical module 2 in such a way that the laser intensity over the cross section of the particle flow (y-direction) is as uniform (constant) as possible in the optical measurement volume (optical sensing zone). If this is not the case, the deviation can be measured by measuring the location-dependent laser intensity or by a normalisation measurement with highly monodisperse particles. The particle size distribution can be corrected by use of the determined local intensity dependence through correction factors and the assumption of statistically uniformly distributed particles in the flow path 21, FIG. 2b.

When a particle passes through the laser focus, the light is scattered into space. As an example, the optical modules 8 and 9 are drawn for forward scattering 6 and sideward scattering 7 for a particle in the laser focus. These modules collect the light, block out the direct beam (e.g. by beam stop) (only 6), contain the reception optics and focus the light scattered in a certain area onto e.g. photomultipliers 11a, 11b. Depending on the measurement requirements, said photomultipliers can be identical or functionally adapted for the different radiation angles. The use of e.g. photodiodes and avalanche photodiodes is also possible. By use of cameras 12, the semi-transparent mirrors 10 facilitate the adjustment of the beam paths. The camera is used to assess the image of the scattering particle flow in the measurement zone according to sharpness and the position thereof relative to the pinhole. Only when the edges of the pinhole and the scattered light signals appear “sharp” can the image of the measurement volume be narrowed down by the smallest possible aperture. This fades out part of the background radiation. It must also be ensured that the aperture does not obscure part of the image from the particle scattering in order to avoid broadening of the PSD and errors in the particle concentration as a result.

According to the invention, identical or differently shaped “beam stops” (e.g. with different diameters) can be inserted one after the other in the forward scattering beam 6—before or after the reception optics (lens) —, or an aperture of a constant size can be moved in the diverging scattered light cone (or focusing cone) in order to realise different reception angle ranges. Ring-shaped detectors that each cover a differential angle range can also be combined. Ring detectors having different radii and beam stops can also be arranged, for example, in a component in four quadrants with associated radiation receivers. This eliminates the mechanical placement of e.g. the beam stops for the implementation of different reception angles.

Essential for a high counting accuracy is the passage of only one particle at a time through the measuring volume detected by the focused laser beam. This can be practically achieved for liquid-borne particles by hydrodynamic and for air-borne particles by aerodynamic focusing of the measurement sample. The maximum sample volume flow as a function of particle concentration can be estimated using an approach from the literature (Analytical Chemistry 1987 59 (6), 846-850, DOI: 10.1021/ac00133a013).

FIG. 2a shows a typical flow arrangement (fluidics) with a vertically aligned flow cell 5 with hydrodynamic focusing. The flow cell 5 is typically cuboid-shaped (outer dimensions e.g. 10 mm×10 mm, height e.g. 30 mm, other dimensions are also possible) and consists of highly transparent material (e.g. quartz glass). The inner cross section is e.g. 1,500 μm×1,500 μm or 200 μm×200 μm. Other geometries and cross sections can also be used. The flow cell 5 further has an inflow for the sheath flow 13 and the sample inflow 14 as well as the outflow 15. The sheath flow 13 is delivered from a reservoir 17 via a pressure generation device 18 in a controlled and pulsation-free manner. This is implemented e.g. by an adjustable gravimetric generated pressure difference. Specific geometries in the inflow area 13, 5 can be used to stabilise a laminar flow. The sample flow 19 is delivered via a volume-controlled, calibratable syringe pump 20, e.g. with a nominal volume of 0.5 to 2 ml. Larger and smaller delivery volumes can also be used. It should be emphasised that all dispersed particles flowing through the measurement cell are thus analyzed and not only a small percentage as indicated in EP 2 388 569 A1. In order to minimise the sample volume to e.g. 80 μL or 400 μL, preferably 250 μL, an additional port e.g. for Hamilton syringes of different volumes and a correspondingly dimensioned sample loop can be integrated in the supply line 14. The cross section of the flow path 21 in the flow cell 5 (FIG. 2b) can be adjusted manually or automatically, over wide-ranging limits, by use of the sheath to sample flow ratio on the basis of sample count values that are either known or collected at the beginning of the experiment (for example, the diameter of the sample flow (4, FIG. 1b) can be variably adjusted from 5 μm to 30 μm diameter).

According to an approach from the literature (Analytical Chemistry 1987 59 (6), 846-850, DOI: 10.1021/ac00133a013), the sample flow diameter can be calculated on the basis of the two flow rates for sheath flow and sample flow. For example, for a laser beam height of 15 μm (small radius of the beam cross section (16), assumed to be elliptical as an example) and a sample flow in the measurement cell of, for example, 0.3 μL or 1.2 μL, the geometric optical measurement volume is thus, for example, 10 μL or 295 μL, respectively. According to the invention, these values can be adjusted by use of the variable fluidics to smaller volumes, e.g. to shift the measurement sensitivity for smaller nanoparticles, and to larger volumes, e.g. to reduce the measurement time. Thus, as required by object to be achieved, initial sample concentrations in an e.g. 10,000-fold concentration range can be measured only by suitable flow rates of the sample flow and/or the sheath flow and without dilution and change of the mechanical arrangement or the flow cell geometry. At e.g. sample flow rates of (300-1200) nL/min and concentrations of 10⁹ particles per millilitre, it is possible to measure practically without coincidence and to collect the particle count very accurately with a relative error of less than 1%. Thus, samples with a particle concentration of at least up to 10⁹ particles per mL, for example, can be typically analyzed by single-particle detection. In order to achieve the necessary wide size measurement range over 3-4 decades, the flow cell 5 and the fluidics are designed and implemented in such a way that the supply of the sheath flow 13 and the sample supply 14 are possible from above or from below. This prevents counting losses due to sedimentation of larger particles or creaming of larger droplets. In addition or instead, it is also possible to use devices such as one or more mixers in the sample feed system to supply the sample to the flow cell 5 without particle losses.

Instead of hydrodynamic focusing, acoustic centralisation in the measurement volume 4 of the particles in the centre of the flow cell 5 is also possible.

Special devices for sequential sample taking from reactors or pipelines and supply via 14 also allow practically continuous measurement of e.g. production processes (on-line). It is advantageous to use optical sensors or other suitable measurement sensors to check the primary initial particle concentration and, if the initial concentration of the primary sample taken from the process is too high, to implement one or more dilution steps via calibratable mixers and to integrate these steps into the overall measuring system both technically and in the Standard Operational Procedures (SOPs), e.g. in a software-supported manner by use of appropriate software (e.g. SEPView), and to include these steps in the concentration calculations.

The incident laser beam 3 passes through the flow cell 5 and interacts with the hydrodynamically or aerodynamically isolated particles in the sample flow 21. The scattered radiation (e.g. forward 6 and sideward 7) emerges from the flowcell 5.

In principle, it is also possible to use e.g. two different lasers with incident beams 3 thar are parallel or, for example, offset by 90° to improve the measurement resolution for individual applications. Practically, with parallel incident beams 3, the difference in height with respect to the flow cell 5 is very small, without the two beams interacting. The intensity/time curves of the scattering events recorded using the two lasers must be synchronised accordingly.

The design of the aerodynamic focusing is similar to the hydrodynamic focusing. The aerosol beam is surrounded by a clean air jacket and constricted by the ratio of sample volume flow and enveloping flow volume of the air jacket as well as the shape of the suction nozzle in the flow cell 5.

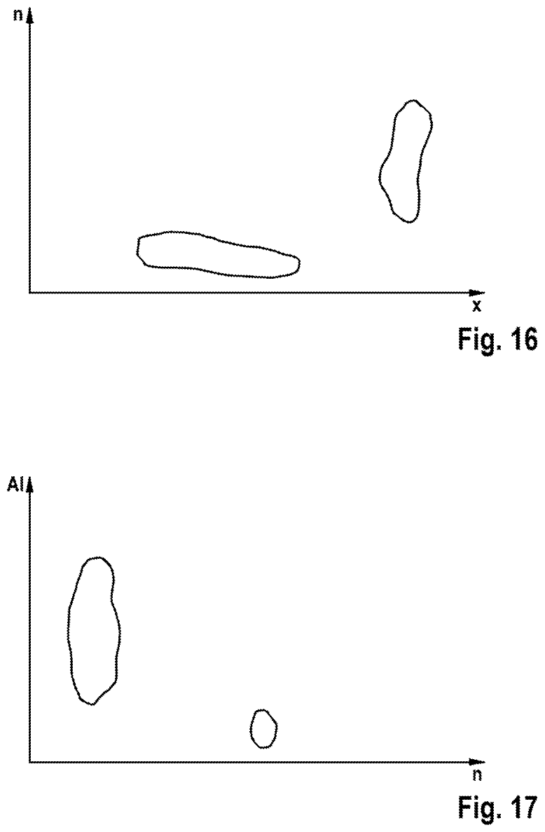

As a result of an aspherically shaped laser beam (16, FIG. 1b), the invention is characterized by a very low intensity dependence over the cross section of the beam in comparison with the typically occurring Gaussian distribution of a spherically focused laser beam (see EP 2388569 A1). In the elliptical beam cross section shown as an example in FIG. 16, a sufficiently uniform laser intensity over the optical measurement range can be achieved by a large axial ratio. Moreover, by simulation calculations of the optical conditions with a known intensity distribution of the primary beam of the laser 1 or on the basis of an experimental determination of the intensity distribution in the recorded measurement flow, errors can be corrected, for example, by integration over the measurable range and determination of the deviation factors from a constant intensity distribution, the technically realised intensity curve and thus precise grain size distributions can be obtained.

To extend the sensitivity of the measurement system into the lower nano range, it is necessary in particular to reduce the optical measurement volume, to minimise the scattered radiation from component surfaces in the optical range, and to use a low-noise laser 1. An encapsulated laser module (1, 2) with integrated micro-optics and a minimised exit window enables a significant reduction of unwanted scattered radiation.

Solutions according to the invention for improving the noise-to-signal ratio are also used in the region of flow cell 5 and scattered beam detection optics. In the flowcell 5, for example, only the necessary entrance or exit windows for the radiation have to be made transparent. This can be achieved, for example, by using glass or partially coated inner walls with different degrees of transparency. Also in the region of the detection optics (e.g. 8, 9, 10, 11a and 11 b), additional optical components, such as multi-level diffractive optical elements, or absorbing coatings, e.g. Vantablack®, can be used.

Electronic Structure:

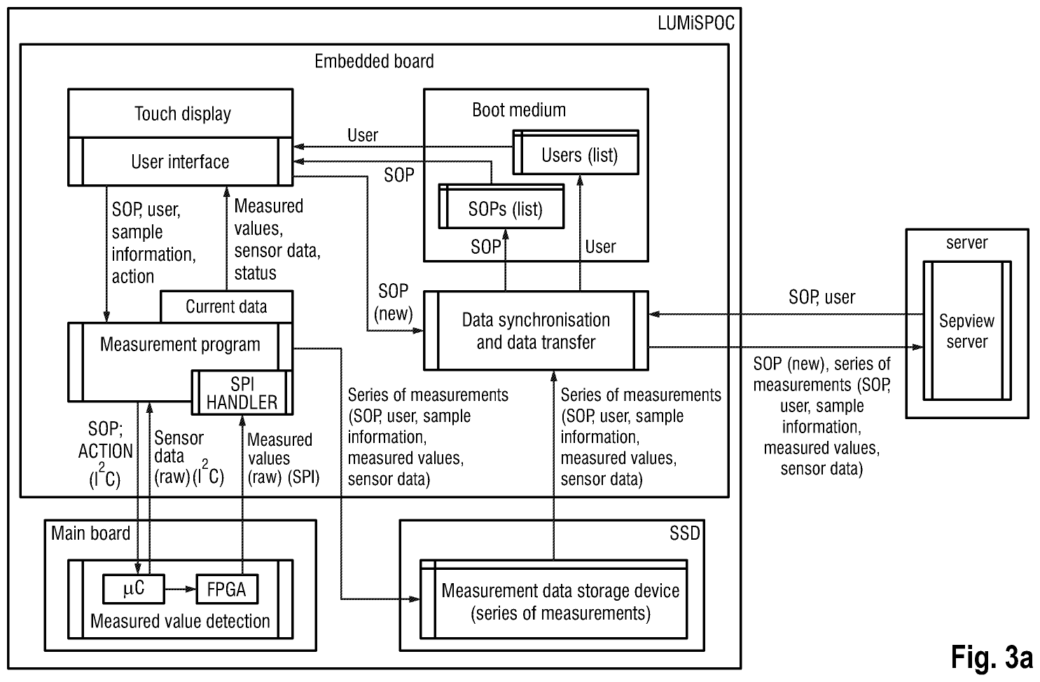

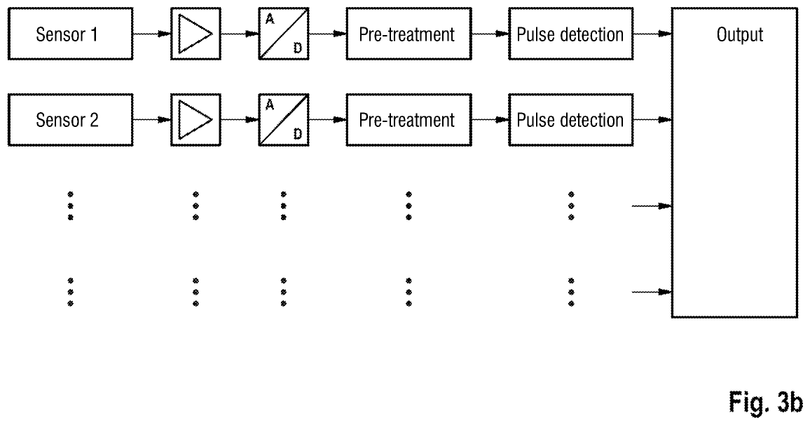

FIG. 3a gives an overview of the main functional elements of the electronic assembly developed according to the invention, based on an embedded board with an operating interface, boot media, at least one micro-controller supported by one or more FPGA(s) and fast mass storage devices (e.g. SSD). FIG. 3a also reflects the basic principles of networking and information flow between the PC-based or server-based software SEPView and the electronic assembly, which allows real-time communication at high speed in both directions.

The most important electronic information-processing components are shown schematically in FIG. 3b as an example for e.g. two scattered light sensors, which can differ in the scattering angle or aperture angle. The use of further sensors, e.g. also for temperature, flow rates, filling level of the storage vessels, laser intensity, optical adjustment, cameras, etc. logically also has to be envisaged.

Supplied by the sensors, the analogue signals for the intensity pulses emanating from the individual particles are first amplified by a low-noise, advantageously linear two-stage amplifier with automatic switching and then digitised in real time by analogue/digital converters. According to the scattering intensity, which decreases significantly with the particle size, a very wideband amplifiers of e.g. 120 dB have to be used. These amplifiers have to be designed in such a way that recorded scattering events from the sensors can be processed with a highly variable frequency (clock frequency), e.g. from 20 Hz to 10 kHz, advantageously up to very high frequencies in the range of 50 to 100 kHz, in order to obtain statistically reliable counting events (numbers of particles in the respective size classes, e.g. from 80 nm to 100 nm) within a short measuring time, and to rule out changes in the sample during the measurement time, e.g. due to sedimentation or particle-on-wall contact, in particular for determining concentration. Moreover, rapid changes in the dispersed phase, e.g. dissolution behaviour or agglomeration rates, can also be measured. The amplifiers developed for the invention can be operated both in linear mode (for high-resolution pulses or monomodal particles) and in logarithmic mode (broad distributions over several orders of magnitude). In order to achieve the high resolution required for pulse evaluation, AD converters with e.g. 20 to 24 bits and a sampling rate range of 0.1 to 25 MS/s, advantageously 1-5 MS/s, have to be used.

In the pre-treatment of the digital values, very short interference pulses and invalid converter results are filtered out and discarded by special algorithms. Offset treatment also has to be implemented here.

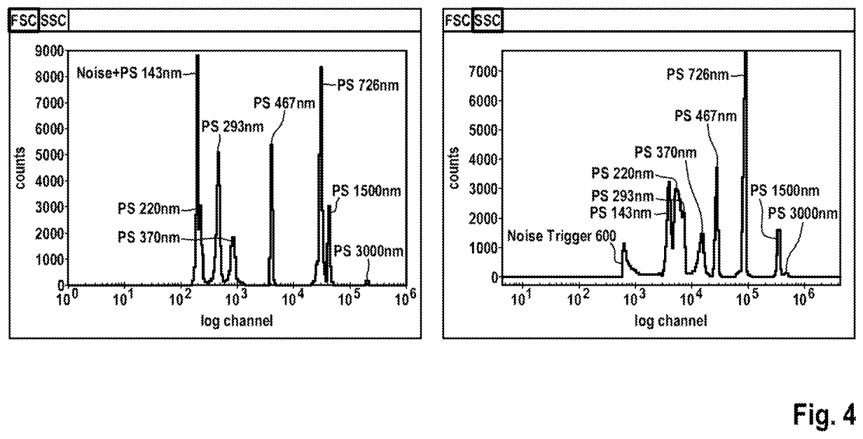

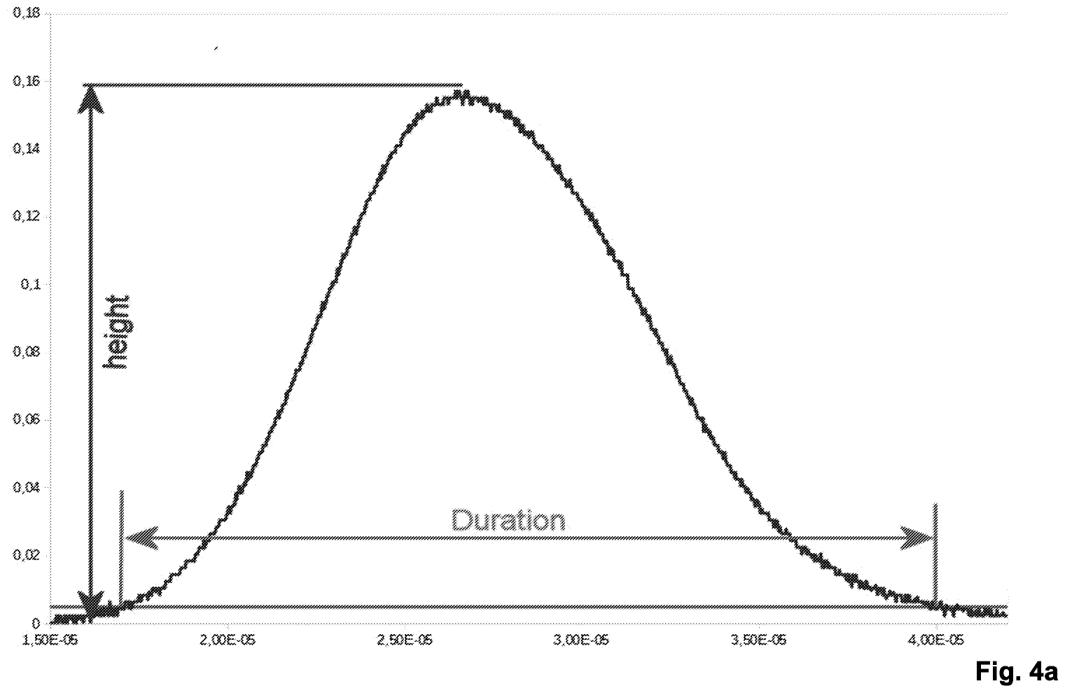

Special pulse detection electronics/firmware evaluate the digitised data stream in real time and identifies pulses that can be evaluated. Invalid pulses are discarded. Invalid data includes pulses that are too long, pulses that are too short or pulses below the trigger threshold. After digitising valid pulses, characteristic values of the pulse of the particular individual particle, such as the maximum of the pulse, intensity (FIG. 4a), duration of the pulse and area under the pulse signal are determined in real time for each particle in the FPGA. The digitised pulse with e.g. 100 interpolation points including an adjustable time advance as well as the determined characteristics are stored or transferred in real time to the embedded board and classified in up to 10⁶ bins in a highly sensitive manner. Via the operating interface, the number of bins can be advantageously selected between e.g. 10 and 10⁶, and thus particle classes can be combined as desired. The pulse classification is displayed on the operating interface in real time. Additional supporting electronics provide the parameters for pulse detection and sensor adjustment. These SOP parameters are requested from the SEPView server or created via the operating interface and transferred from the embedded board to the electronics. All data streams from the different sensors are time-stamped and allow synchronisation for visualisation and analysis.

Software:

SEPView® consists of a total of three functional software components. The first integral component of SEPView® is a platform-independent application server that communicates with the above-described measurement instrument. The communication takes place by use of a specially developed communication protocol which, according to the invention, allows parallel data input and SOP programming/modification both via the server and directly via the operating interface by the embedded computer of the measuring device. The central component of the SEPView® server is a document-based database in which the complete master and transaction data of SEPView® are persistently stored.

The second integral component of SEPView® is the SEPView® Explorer, which reproduces the interface to the user and is advantageously implemented as a platform-independent web interface. By using the web browser, extensive data visualisations, e.g. scattered light single pulses as well as the classification of the different collected particle parameters are achieved with the involvement of the graphics processor, analyzed in real time during the measurement and displayed on the operating interface. Access to the SEPView® Explorer is authorised exclusively.

The third component is the SEPView® Recorder. It is launched from the SEPView® Explorer, controls the entire measurement according to the SOP adopted by the user, e.g. SOP adopted by the server or SOP specially programmed through the operating interface, visualises the synchronised scattered light pulses, e.g. for different aperture angles or scattered light directions, as well as specified measurement parameters in real time and records the processed SOP, all functional states and the measurement data. The client-server architecture decouples the administrative, process and analytical levels from one another and can thus be adapted to the particular client processes and allows distributed collaboration.

FIG. 4 shows typical results of the simultaneous recording of single particle scattering in the forward (left) and sideward (right) direction for a mix of monomodal particle types (material: polystyrene) with a nominal diameter range of 143 nm to 3,000 nm (logarithmic representation). According to the invention, the different-sized particles in the mixed sample were measured simultaneously with an identical SOP and without any change/adjustment of the measurement chamber geometry. For an improved analysis, the forward and sideward scattering is also displayed as a 2-dimensional plot (axes: forward (Y-axis) over sideward (X-axis) or vice versa). Each particle then corresponds to a point in the graph, which quantifies the measured intensities in the selected scattering or extinction channels. The point density corresponds to the number of particles with these features. This advantageously makes it possible to detect particles of the same size of different materials as well as coated or non-coated particles.

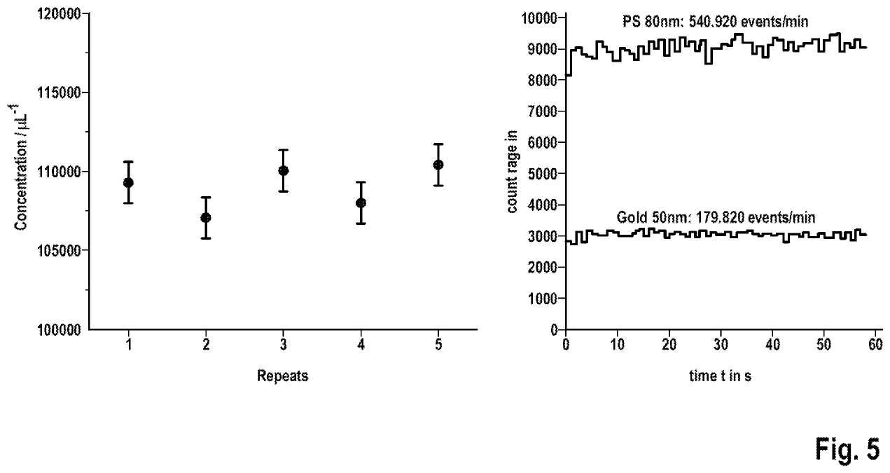

FIG. 5 (left) shows the results for determining the concentration of polystyrene particles with a size of 726 nm. Shown are the mean values with standard deviation for five repetitions (measurement time of 1 minute each). The mean concentration is 108,960+/−640 particles per microlitre. The standard deviation is only 0.6% and demonstrates the high counting stability of the developed method. FIG. 5 (right) shows the pure count rate for polystyrene (80 nm) and nanogold particles (50 nm). As can be seen, even at a very high count rate of approx. 9,000 Hz (events/s) in this example, the inventive solution allows the recording of a constant, drift-free count value over the measurement time (one minute in the illustrated example). Thus, after calibration of the syringe pump that conveys the measurement sample, the proposed method allows microscale and also nanoscale dispersed particles in particular to be very effectively determined (particles per mL).

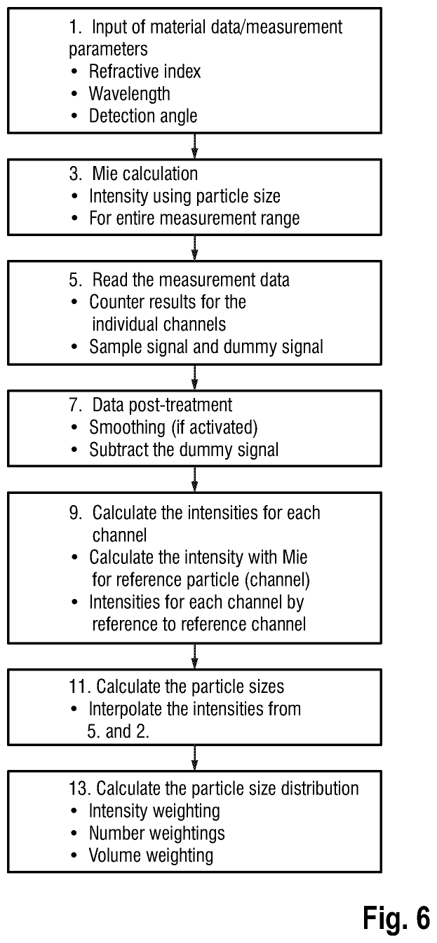

FIG. 6 shows one possible sequence of the analysis steps of a downstream analysis of a sample measurement with the aim of calculating particle parameters (e.g. particle size in this case) using the measurement method according to the invention.

### 2. Exemplary Embodiments

In the following, individual exemplary embodiments of the inventive solution for determining particle characteristics are presented by way of example and explained in more detail. All of the following calculations refer to a laser wavelength of 532 nm by way of example. Other wavelengths, e.g. in the NIR, SL or UV, can also be used and make it possible to improve the resolution/sensitivity or the dynamic measurement range for selected applications. For example, reducing the wavelength allows smaller particles to be detected, and increasing the wavelength allows larger particles to be detected, without entering the ambiguous territory of Mie theory. The particles are typically dispersed in water. However, depending on the materials used for fluidics and the optical requirements, any liquids, solutions, solvents, etc. or gases can be used as the carrier medium. For certain applications, the choice of liquids can increase the refractive index contrast, for example, and thus shift the detection of nanoparticles into the single-digit nanometre range or allow resolution for particles with very small size differences (e.g. <5 nm).

The scattered light curves necessary for the description of the invention are calculated for the example particles according to Mie theory. The calculations are stopped at a particle diameter of 10 μm since this size range is sufficient to explain the situations according to the invention. The reception angles for the scattered light measurements, selected according to number and angle range, are arbitrary and can be adjusted as desired. 10.33° is the upper fixed limit angle of e.g. a non-commercial photometer, which is used for the sake of simplicity.

Four angles are selected for the lower variable reception angle limits for the example calculations. φ=4°, 5°, 6° and 8°, such that the angle ranges between φ and 10.33° can be used for the evaluation as required. It should be emphasised that these angles can be set to be highly variable. With an appropriate optical arrangement, the lower limit angle can also be less than 1°.

### a) Enlargement of the Application Range of Scattered Light Measurements for the Size Determination of Microscale Particles with a Known Refractive Index

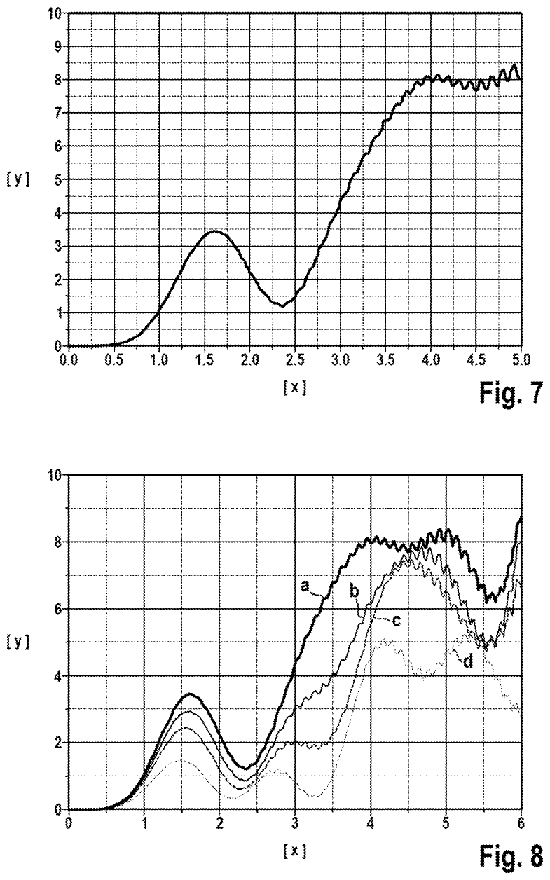

“Usually”, the forward scattering is used to determine the size of particles that are outside the Rayleigh scattering range, and the intensity is measured in a certain angle range. Since the scattered light intensity first increases monotonically as a function of the particle size, but has maxima and minima for larger particles (FIG. 7-13), and thus does not allow a one-to-one assignment to the particle size, an unambiguous determination of the size as a function of optical properties thereof is not possible for dispersions for size classes of a few micrometres and higher.

As shown in FIG. 7, the particle size of frequently used reference particles (polystyrene) can only be unambiguously determined up to a diameter of 1.17 μm at an aperture angle of 4° to 10.33°. The scattered light intensity in FIG. 7 is then I=1.2. At a slightly higher scattered light intensity, a particle diameter of 2.36 μm according to Mie is also possible. According to the invention, this ambiguity is eliminated by measurements in multiple angle ranges (FIG. 8).

With a scattered light intensity of e.g. I=2, the particle sizes 1.20 μm, 2.05 μm and 2.63 μm can be read in the angle range of 4° 12.33° according to FIG. 8. To resolve the ambiguity, the angle range of 6° to 12.33°, for example, can be used for an additional measurement (FIG. 8) to determine the real size of the particle. In this angle range, the scattering intensities based on Mie calculations for the possible particle sizes determined in the angle range of 4° to 12.33° are 1.59 (1.20 μm), 1.04 (2.05 μm) and 1.34 (2.63 μm), respectively. The differences in intensity are sufficiently large, so that an unambiguous (correct) diameter can be assigned to the particle. If an intensity of e.g. 1.04 is measured for the second angle range in the experiment, the particle size is 2.05 μm. If the intensities determined for the second angle range do not match the calculations, it is reasonable to assume that the observed particle is aspherical. An exact measurement and evaluation of the pulse shape can quantify this optical particle feature. In addition to Rayleigh-Debye-Gans theory (only valid for a limited application), other theories that deal with asphericity (e.g. discrete dipole approximation) can also be used to obtain specific quantitative parameters.

A similar procedure can be followed after a measurement in the angle range of 4° to 12.33° in the particle size range of 4.0 μm to 5.0 μm. In this case, a combination of the angle ranges 6° to 12.33° and 8° to 12.33° is suitable. The particle size of 5.9 μm, which is also possible, is decided by the latter curve. In this case, the measured intensity should be 3 if the particle has this diameter.

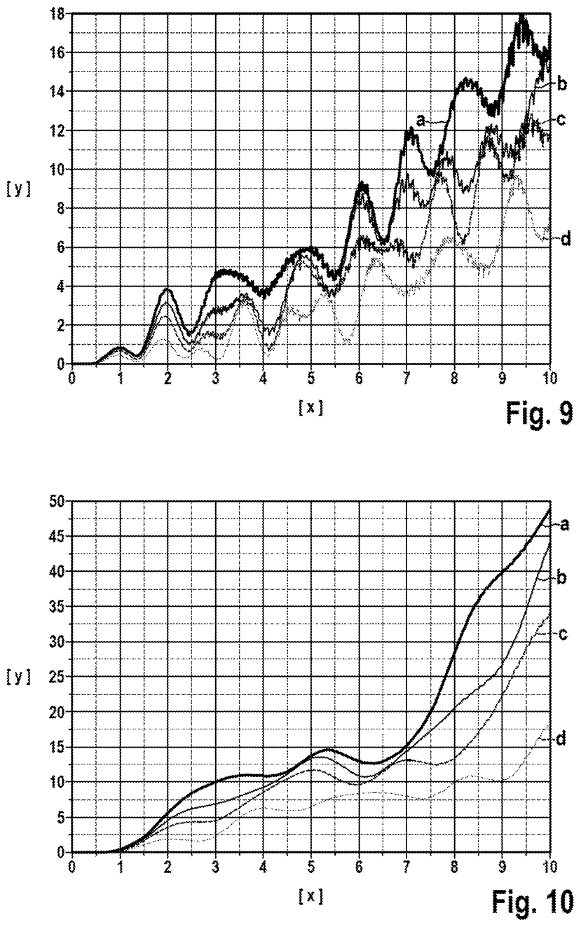

As a further example, a scattered light intensity of I=14 is to be examined for a dispersion with particles with a refractive index of 1.8 (FIG. 9).

In the angle range of 4° to 12.33°, the possible particle diameters are 8.1 μm, 8.5 μm and 9.0 μm. In order to eliminate the ambiguity, measurements must be carried out in a second angle range according to the invention. In the angle range of 6° to 12.33°, the corresponding intensities are 6.6, 9.5 and 10.1. If the difference 9.5 and 10.1 does not appear sufficient for a determination, the angle range 8° to 12.33° can be used. In this case, the intensities are 4.8 and 7.1.

It can also be seen from the examples that it is possible to identify from the theoretical Mie calculations which angle ranges can still be used for the experimental decision after an initial measurement.

In addition, it is clearly evident that, for particles with a diameter larger than 10 μm, the scattered light curves differ more significantly from one another in the four angular ranges considered here, meaning that an assignment is even easier.

### b) Simultaneous Determination of Particle Size and Refractive Index

This part of the description of the invention extends application a) for the case of an unknown refractive index of the particular particle for the simultaneous experimental determination of refractive index and particle size.

The procedure described under a) remains the same in principle. Already in the four arbitrarily chosen reception angle ranges of embodiment example a), there is no four-matrix of the scattered light intensities in the angle ranges with the same values for different refractive index and particle size. If the experimental measurement error of the scattered intensity is greater than the required accuracy, it is also possible here to use a further angle range (e.g. smaller than 4°) or, as shown in FIG. 1a, to additionally simultaneously use the sideward scattering, e.g. at an angle of 90°, for a determination of the particle parameters.

In this case too, as in the examples already explained, if the intensity values are not consistent, it must be concluded that the particles are not spherical, quantifiable e.g. by pulse shape analysis.

The refractive index of many particles of a substance is different due to the production process, e.g. in the case of SiO₂ (porosity). With the proposed invention, it is possible to determine even small refractive index differences between analyzed particles (silicon dioxide in this case). This is to be shown, by way of example, on corresponding scattered light curves for n=1.46 and n=1.47.

For particles larger than 3 μm, the assignment is unproblematic (FIG. 10 and FIG. 11). A superimposition of e.g. FIGS. 10 and 11 demonstrates that the intensities between the angle ranges are sufficiently different.

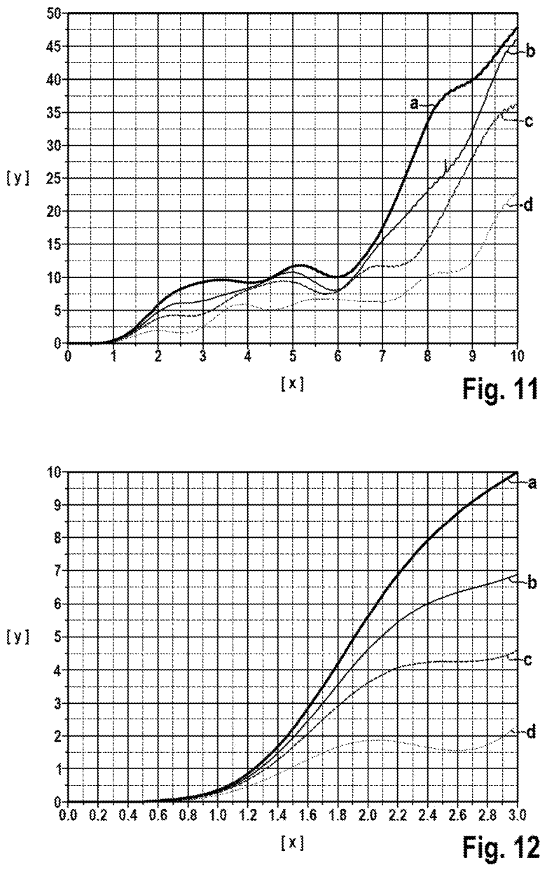

The unambiguous assignment of the refractive index according to the invention for particles of unknown size for arbitrarily selected diameters, e.g. of 2 μm and 0.5 μm, will now be described; for the sake of simplicity, SiO₂ was also taken as a basis, by way of an example (FIG. 12 and FIG. 13 and FIG. 14 and FIG. 15, respectively).

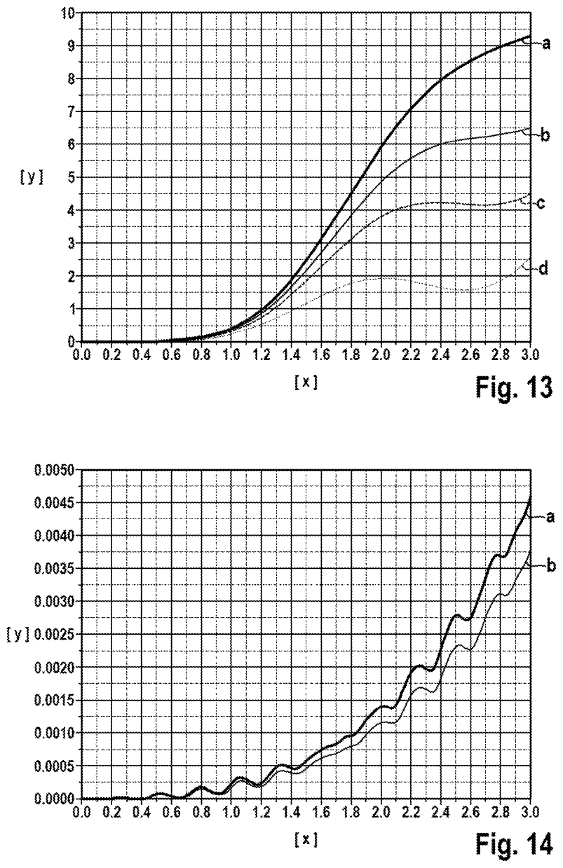

As shown in FIG. 12, particles with a diameter of 2.00 μm and a refractive index of n=1.46 have, for example, in the reception angle range 4° of 12.33°, a scattering intensity of I=5.60 according to Mie. However, ambiguity occurs since particles with a refractive index of n=1.47 for a particle diameter of 1.95 μm also have this intensity (FIG. 13). If the reception angle range of 8° to 12.33° is also used, particles with a diameter of 2 μm and n=1.46 scatter with an intensity of I=1.84 (FIG. 12). The intensity ratio is 3.044. In the case of an assumed refractive index of n=1.47, this results in a scattering intensity of I=1.91 (FIG. 13) and an intensity ratio of 2.93. To validate/confirm the determined refractive index, sideward scattering could additionally be used (FIG. 14).

To calculate the Mie intensity of the sideward scattering, for example, half the aperture angle(10.02°) of the photometer drawn in FIG. 1 was adopted at A=532 nm.

For a particle diameter of 2.00, the scattered light intensity is calculated as I=0.00116. The scattered light intensity for a particle with n=1.47 and a diameter of 1.95 μm is approx. 20% greater (I=0.00133). To generalise, it can be stated that for particles with a size parameter of about k less than or approximately equal to 20, sideways scattering should be used. The size parameter k is calculated as follows:

k=πn x/λ

x: Particle diameter
n: Refractive index of the continuous phase (dispersion medium)
λ: Wavelength of radiation in a vacuum

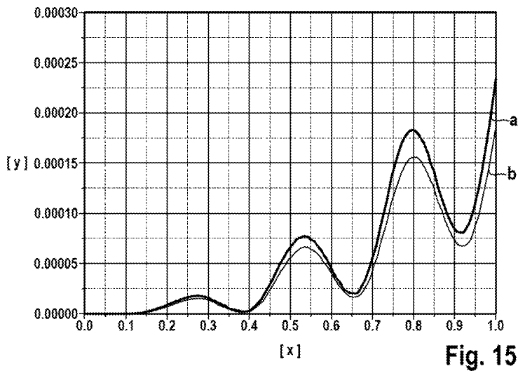

The determination of both size and refractive index (1.46 or 1.47) will now be demonstrated for particles with a size of 0.5 μm as an example. In the angle range of 8° to 12.33°, an intensity of I=0.00765 is measured. This corresponds to either 0.500 μm (n=1.46) or 0.487 μm (n=1.47). In the other three reception angle ranges considered here for forward scattering, the corresponding intensities differ by only about 1%. With the help of the side scattering at an angle of 90°, the following is obtained, according to FIG. 15: I=5.68 10⁻⁵ (0.500 μm; n=1.46) and I=5.91 10⁻⁵ (0.487 μm; n=1.47). The intensity differences are large enough to be able to make a decision.

For the initial measurement in the range to 4° to 12.33°, it should be noted that, as with measurements in general, measurement inaccuracy may occur.

In general, the requirements for the measurement accuracy of the intensity of the scattered light curves should be determined by the dependence of the change in the scattered light intensity on the particle size (e.g. FIG. 14). In the case of a larger dependency of the scattered light intensity on the particle size (steep portions, e.g. FIG. 15 in the size range of 0.70 μm to 0.75 μm), errors of a few percent are negligible.

If the necessary measuring accuracy is not achieved, additional angular ranges should be considered, for example.

The smaller the particles, the smaller the intensity differences in the reception angle ranges. They are no longer present in the Rayleigh range.

For particles with refractive indices larger than SiO₂ (n=1.46 to 1.47), the determination of both size and refractive index tends to be easier for small particles (around 0.5 μm).

The refractive indices determined for each particle are to be ordered or classified according to size and produce a number-based distribution of the refractive index feature for the total population measured. If the refractive index is plotted for each particle against the particular scattering intensity or the particle size determined therefrom in a 2D plot (cf. also FIG. 16), subpopulations can be identified in their entirety and conclusions can be drawn about the uniformity of the particle types in the measurement sample.

The determination of the extinction coefficient (n″) is also possible in principle. Due to the occurrence of another variable, more reception angles must then be used for the measurements in order to make a decision among the increased ambiguities since the number of possible combinations is then significantly increased.

For the invention, the way in which the different reception angle ranges are achieved is irrelevant.

In a photometer, different “beam stops” can be inserted one after the other in the diameter—before or after the reception optics (objective). An aperture of constant size can be moved in the diverging scattered light cone (or focusing cone) to achieve different receiving angle ranges.

It is also possible to combine ring-shaped detectors that each cover a differential angle range. Different apertures in circular sectors can also be inserted. The scattered light intensities for the implemented arrangements would then have to be recorded separately and individually by experiment, e.g. with a mirrored prism or a location-sensitive photomultiplier. Advantageously, the repeat measurements in other angle ranges described in the previous examples are omitted, which advantageously reduces the experimental effort and increases the measurement accuracy through the simultaneous measurement of different angle ranges for the same particle.

In principle, multiple devices could also be used. However, even with an identical technical set-up, identical adjustment and calibration, a lower selectivity has to be assumed.

### c) Determination of the Sphericity in the Case of a Single-particle Scattered Light Photometer

Besides the refractive index, the optical property of a particle is also determined by its geometry (e.g. spherical, prismatic, ellipsoidal, cylindrical or irregular etc.). Mie theory, which is most commonly used for determining particle size by light scattering, only applies to spherical particles. It is known from the theory of light scattering that the scattering behaviour of spherical and aspherical particles of the same volume is different.

Aspherical particles cannot be described with the methods disclosed in sections a) and b). However, if this method is used, the theoretical Mie scattering intensities will not match for different scattering angles and aperture angles. At the same time, this means that the particle under investigation must be qualitatively classified as aspherical. This has already been pointed out multiple times in sections a) and b). The quantitative “asphericity index” (Al) can be defined, for example, as the percentage difference between the ratio of the theoretical Mie scattering intensities calculated for two (or more) aperture angles and the ratio of the scattering intensities determined experimentally at the same aperture angles. Other defined measures are also possible. Similarly, the “asphericity index” can be determined from theoretical calculations of the intensity for two scattering directions and the experimentally determined intensity ratio for corresponding scattering directions.

The inventive solution also allows a second procedure for determining the “asphericity” of the particles. In order to determine the sphericity, the entire curve of intensity of the scattered light pulse over time during the passage of the particle through the measurement volume (FIG. 1b) is measured by the scattered light apparatus and analyzed or stored in real time. It is also possible to store the curve of the scattered intensity over time and to evaluate the curve later.

If the intensity distribution in the laser focus is known, the sphericity of the particle can be derived from the determined experimental intensity curve when the particle passes through the laser focus and by use of deconvolution. Furthermore, according to the invention, a theoretical pulse duration for the particle can be calculated from the comparison of the determined size according to Mie (spherical assumption) and taking into account the experimentally calibrated sample volume flow. The comparison of the experimentally measured pulse duration for each particle after high-resolution digitisation (FIG. 4a) with the theoretically calculated sphere-equivalent time period makes it possible, according to the invention, to detect even small deviations and thus quantify asphericities with high resolution.

The quantitative particle geometry features defined in this way are to be ordered according to intensity or also size and produce a number-based distribution of the feature in the measured total population. If the “asphericity index—Al” is plotted for each particle against the scattering intensity or the particle size determined therefrom, the distribution of “Al” in the sample can be quantified or possible subpopulations in the sample as a whole can be identified. In addition to the particle size determined according to Mie, the distribution can also be plotted with respect to the determined refractive index. For example, FIG. 17 would suggest that the disperse phase consists of two particle subfractions with different refractive indices (different material or non-uniform core/shell particle) and that the fraction with the lower refractive index has a stronger scattering with respect to the asphericity index.

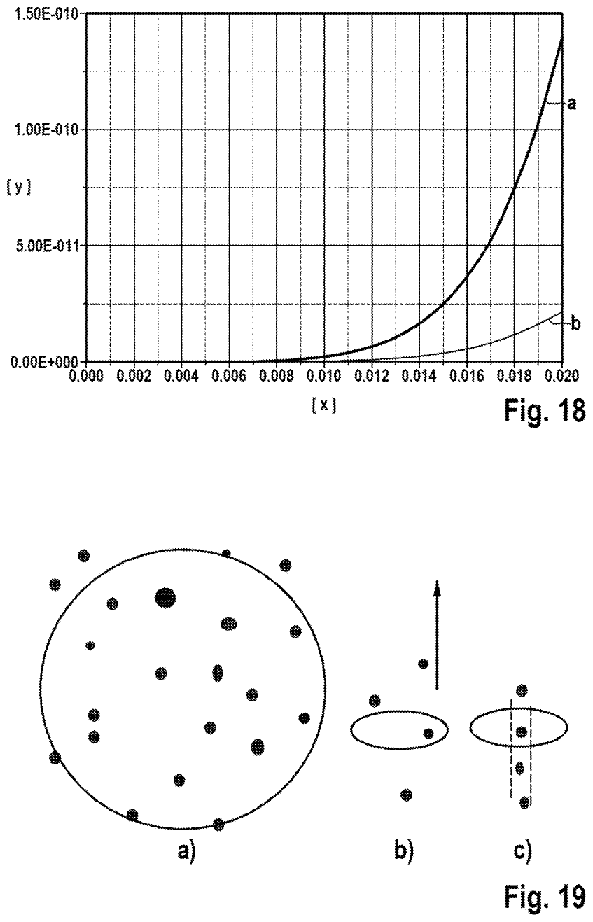

Application examples a) to c) were described for hydrodynamic focusing, since the methodological challenges here are much greater due to the significantly lower scattered light intensities (lower refractive index contrast for liquid/particles compared with air/particles). Applications for aerodynamic focusing, however, follow in principle the same inventive solution approaches. In particular, the measurement limits will shift advantageously to much smaller particle sizes down to the single-digit nanometre range since the refractive index contrast is increased several times over and the proportion of signal noise is significantly minimised as a result of the larger scattered light intensities. This situation is illustrated in FIG. 18 for silicon dioxide particles in air (n=1.000) and water (n=1.334). A 20 nm particle has a scattered light intensity approx. 100 times greater.

### d) Extinction Modules with Hydrodynamic Focusing

The invention in a) to c) also has the inventive object of dispensing with extinction measurements (Fraunhofer's approximation solution) that are subject to errors. However, if doubts remain for non-spherical particles with the methods and calculations described, it is expedient to use extinction measurements.

For this purpose, the primary beam can be deflected after the flowcell 5, before the beam stop, and evaluated as known.

A second possibility of dispensing with this additional measurement arm and shift the measurement limit to smaller particle sizes is shown by the solution described below.

An extension of the measurement range to smaller particles is hindered by the sensitivity of the known receivers, which are said to detect small temporal shadows (negative light pulses or “extinction signals”) from a large amount of light when a particle passes through the relatively large measurement zone.

For the measurement of smaller particles, the ratio of constant light intensity of the light source in the cuvette (preferably a laser 1) to an extinction signal is particularly unfavourable.

To improve the ratio, hydrodynamic focusing is helpful, which, in contrast to the state of the art, reduces the original measurement zone for the extinction signal by imaging the entire measurement zone through an optical assembly onto an aperture (preferably a pinhole or rectangular aperture) in such a way that only the area with the extinction signals is not blocked out by said aperture, which are then directed to a receiver. The light next to the hydrodynamically focussed particles is thus blocked to a large extent in the image space. The measurement zone is then determined only by the particle flow diameter and not by the total illuminated area in the cuvette.

This assembly (FIG. 19) succeeds in expanding the lower measurable particle size towards smaller diameters.

In a), particles fill or flow through the entire focus. In b), it is disadvantageous to work with a significantly reduced particle concentration in order to ensure single particle recording since coincidence cases occur in proportion to the measurement volume. Due to the hydrodynamic focusing, higher concentrations (e.g. up to 10¹⁰ particles per ml) can be measured in c). The possible particle flow is marked by the dashed lines. The area outside the particle flow is stopped down.

This set-up presents the challenge of placing the image of the particle stream (i.e. the extinction pulses) precisely in the pinhole or rectangular aperture so that the pulses can also be recorded by the receiver (optically, the brightness fluctuations of smaller particles as they pass through the laser beam are too weak to be detected by a camera). The aim can be achieved either by prior adjustment using a scattered light photometer assembly (similar to FIG. 1a) and subsequent removal of the aperture on the objective, or moving of the pinhole, by use of x, y adjustment (i.e. perpendicular to the laser beam propagation), towards a maximum extinction deflection at a reference latex.

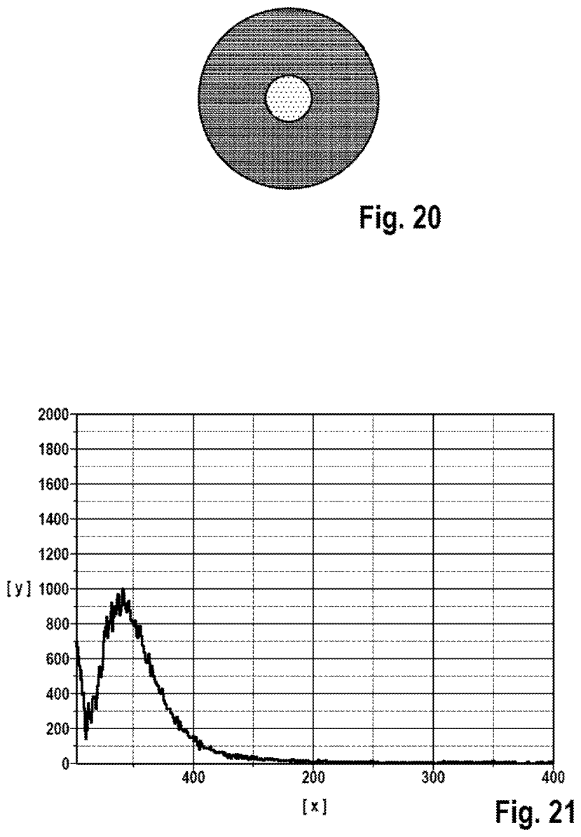

In general, an extinction measurement has the drawback that a large part of the forward scattering also hits the receiver and weakens the extinction pulses. Part of these scattered light pulses can be eliminated by a pinhole aperture inserted in the beam path after the objective, after the adjustments described above, which allows only the primary laser beam to pass through (FIG. 20). This assembly is particularly effective for the determining the size of small particles.

With an experimental set-up described above, polystyrene particles with a diameter of 0.726 μm were able to be well resolved in comparison with the noise level. If the noise level is mathematically suppressed to a large extent with suitable algorithms, it was possible to record (0.55 and 0.50) μm PS and SiO₂ particles, recognisable as shoulders in the original spectrum (FIG. 21). With lower-noise electronics, it can be expected to be possible to shift the accessible particle measurement range further.

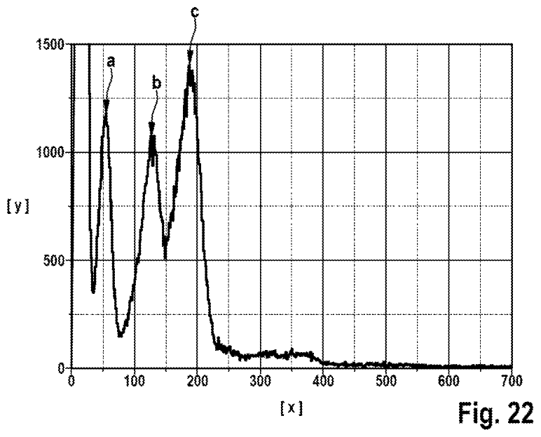

A mixture of 3 different latices in the size range of 0.8 μm to 1.3 μm (peaks a, b and c in FIG. 22) were able to be separated with good resolution.

For more accurate calculation of the particle diameter (no Fraunhofer approximation), a spherical shape and a known refractive index are required. With the photometer described above, these calculations can also be performed without extended calibration curves, only with measurement of a size standard, since the angle range in which scattered radiation also reaches the detector is known. By calculating the scattered light radiation incident through the known angle of incidence, the particle diameter can be calculated more accurately.

In order to simplify particle size determination or make it possible in the first place, the particles must encounter an almost constant laser intensity. Therefore, it may be necessary to enlarge the laser focus by removing the responsible lenses after the light source.

An existing single-particle scattered-light photometer (according to FIG. 1a) can be extended to a combined device by the modifications described above. The already present aperture in front of or behind the objective (or the entrance lens) for blocking the primary beam is used for adjustment and then removed from the beam path in a suitable manner (e.g. by folding it up). The pinhole aperture for reducing the stray light signals is brought into the beam path (but must be removed for adjustment).

The primary beam path with the extinction signals is either directed to the photomultiplier after attenuation, e.g. by an optical neutral filter, or deflected, possibly without a filter, to another receiver.

### Examples

The following examples summarize what has been disclosed herein:

1. A method for determining the properties of microscale and sub-microscale particles in measurement samples by multiparametric detection of extinction and/or scattered light signals, characterized in that the scattered light and extinction signals of each individual dispersed particle are counted and simultaneously measured in at least two spatial angle ranges with a high detection rate (frequency) and compared in an analogue or digital manner with simulation calculations of the scattered light distribution by analytical or numerical methods for the different spatial angle ranges in order to determine therefrom individual particle characteristics over a dynamic particle size range of four orders of magnitude without coincidence, even for high particle concentrations (e.g. 10⁹ particles/ml) of the measurement sample.

2. The method according to Example 1, characterized in that different aperture angles are used for the forward scattering or multiple detection directions are used for the scattered light measurement, and any combinations thereof are used.

3. The method according to Example 1 or 2, characterized in that, in the case of particles having size parameters k greater than or approximately equal to 20, different aperture angles are used for the forward scattering.

4. The method according to Example 1 or 2, characterized in that, in the case of particles having hardly distinguishable forward scattered light curves in the different receiving angles (in particular in the case of a size parameter k smaller than or approximately equal to 20), multiple detection directions are used in lateral directions with different sensitivities.

5. The method according to at least one of Examples 1 to 4, characterized in that the simulation calculation is carried out by means of Mie theory or numerical simulation calculations in accordance with the corresponding optical set-up, and from the comparison between theory and experimental scattering intensity, the ambiguities with respect to the particle size are removed, and thus microscale particles up to 100 μm can also be measured.

6. The method according to at least one of Examples 1 to 5, characterized in that optical particle properties, such as size or refractive indices, are determined by consistency testing of the modelled and the experimentally determined intensities of the particle pulses for different aperture angles and/or spatial angle ranges.

7. The method according to at least one of Examples 1 to 6, characterized in that, if the scattered light intensities measured in the angle ranges do not correspond to the possible theoretical intensity matrices of the corresponding particle, asphericity is concluded and quantified by means of an asphericity index.

8. The method according to at least one of Examples 1 to 7, characterized in that, in the case of single particle scattering, the shape of the particle is classified as spherical or non-spherical from the comparison of the experimental, digitised pulse shape of a particle with a known refractive index and the corresponding simulation calculations for spherical particles for the same spatial angle range.

9. The method according to at least one of Examples 1 to 8, characterized in that, in the case of single particle scattering, quantitative results are obtained with the aid of theories which deal with asphericity and/or in that, in the case of single particle scattering, the particle fractions are classified according to the features, e.g. size, shape and refractive index, and the particle numbers per feature unit are determined, displayed and outputted, and/or in that, in the case of single particle scattering, a laser having a variable beam intensity and an aspherical beam cross section (focus) having a constant light intensity at least over the cross section of the sample stream is used, or, in the case of insufficient uniformity of the intensity, this is corrected by mathematical normalisation methods.

10. The method according to Example 1, characterized in that the extent of hydrodynamic or aerodynamic measurement flow focusing can be adjusted manually or automatically by the ratio of the sheath flow to the sample flow, depending on the known initial number concentration of the measurement sample or on the basis of a first measurement cycle.

11. The method according to Example 1, characterized in that, for the size determination of very wide polydisperse samples, no exchange of measurement chambers or changes of the flowcell have to be carried out.

12. The method according to at least one of Examples 1 to 11, characterized in that beam stops are successively inserted or displaced, or ring-shaped detectors that each cover an angle range are used, or different apertures are introduced into circular sectors, the different scattered light signals being measured and evaluated separately.

13. The method according to at least one of Examples 1 to 12 characterized in that, by using ring-shaped detectors or different apertures in circular sectors, the repeat measurements described in the examples in other angular ranges are eliminated, which advantageously reduces the experimental effort and increases the measurement accuracy through the simultaneous measurement of different angle ranges for the same particle.

14. The method according to at least one of Examples 1 to 13, characterized in that, for extinction applications, the ratio of the light intensity of the light source in the cuvette to an extinction signal is improved by hydrodynamic focusing and by masking out the areas illuminated by the primary radiation in the image space that are adjacent to the hydrodynamically focused particles, in order to detect smaller particles.

15. The method according to at least one of Examples 1 to 14, characterized in that, for extinction applications, a pinhole aperture inserted after the objective and having the diameter of the laser primary beam after the objective eliminates a large part of the forward scattering that would also strike the receiver, thereby extending the measurement range to smaller particles and allowing more precise particle size calculations.

16. A device for determining the properties of microscale and sub-microscale particles in measurement samples by multiparametric detection of scattered light and extinction signals, comprising at least one laser (1) for generating at least one laser beam (3), at least one optical input module (2) for shaping the laser beam (3) and forming a focus geometry (16), a flow measuring cell (5), advantageously with hydrodynamic focusing, in which forward scattered light radiation (6) and sideward scattered light radiation (7) are generated by the laser beam (3), optical output modules (8) in the forward scattered light beam (6) and optical output modules (9) in the sideward scattered light beam (7), semi-transparent mirrors (10), cameras (12), photomultipliers (11a, 11b), wherein, by means of the photomultipliers (11a, 11b), scattered light measurements are carried out for a different number of aperture and reception angles, and intensities of the forward scattered light beam (6) and of the sideward scattered light beam (7) are determined from the determined scattered light using evaluation algorithms.

17. Use of the device according to Example 16 for the analysis of multiple features of individual particles or the classification or identification of particle fractions in the industrial and academic fields, such as W/O or O/W emulsions, aerosols, slurries for wafer polishing, ink and pigment suspensions, samples of cellular and sub-cellular particles (including cells, viruses, bacteria) of biological origin or for applications, e.g. the design of nanoparticles, quantification of the stability of dispersions, investigations into the dissolution, agglomeration and flocculation behaviour of disperse phases, quantification of the progress of dispersions, quantification of the progress of dispersions.

What is claimed is:

1. A method for determining the properties of microscale and sub-microscale particles in measurement samples by multiparametric detection of extinction and/or scattered light signals, characterized in that the scattered light and extinction signals of each individual dispersed particle are counted and simultaneously measured in at least two spatial angle ranges with a high detection rate (frequency) and compared in an analogue or digital manner with simulation calculations of the scattered light distribution by analytical or numerical methods for the different spatial angle ranges in order to determine therefrom individual particle characteristics over a dynamic particle size range of four orders of magnitude without coincidence, even for high particle concentrations (e.g. 10⁹ particles/m1) of the measurement sample.

2. The method according to claim 1, wherein different aperture angles are used for the forward scattering or multiple detection directions are used for the scattered light measurement, and any combinations thereof are used.

3. The method according to claim 1, wherein, in the case of particles having size parameters k greater than or approximately equal to 20, different aperture angles are used for the forward scattering.

4. The method according to claim 1, wherein, in the case of particles having hardly distinguishable forward scattered light curves in the different receiving angles (in particular in the case of a size parameter k smaller than or approximately equal to 20), multiple detection directions are used in lateral directions with different sensitivities.

5. The method according to at least one of claim 1, wherein the simulation calculation is carried out by use of Mie theory or numerical simulation calculations in accordance with the corresponding optical set-up, and from the comparison between theory and experimental scattering intensity, the ambiguities with respect to the particle size are removed, and thus microscale particles up to 100 μm can also be measured.

6. The method according to at least one of claim 1, wherein optical particle properties, such as size or refractive indices, are determined by consistency testing of the modelled and the experimentally determined intensities of the particle pulses for different aperture angles and/or spatial angle ranges.

7. The method according to at least one of claim 1, wherein, if the scattered light intensities measured in the angle ranges do not correspond to the possible theoretical intensity matrices of the corresponding particle, asphericity is concluded and quantified by use of an asphericity index.

8. The method according to at least one of claim 1, wherein, in the case of single particle scattering, the shape of the particle is classified as spherical or non-spherical from the comparison of the experimental, digitised pulse shape of a particle with a known refractive index and the corresponding simulation calculations for spherical particles for the same spatial angle range.

9. The method according to at least one of claim 1, wherein:
in the case of single particle scattering, quantitative results are obtained with the aid of theories which deal with asphericity and/or in that, in the case of single particle scattering, the particle fractions are classified according to the features, e.g. size, shape and refractive index, and the particle numbers per feature unit are determined, displayed and outputted,
and/or in that,
in the case of single particle scattering, a laser having a variable beam intensity and an aspherical beam cross section (focus) having a constant light intensity at least over the cross section of the sample stream is used, or, in the case of insufficient uniformity of the intensity, this is corrected by mathematical normalisation methods.

10. The method according to claim 1, wherein the extent of hydrodynamic or aerodynamic measurement flow focusing can be adjusted manually or automatically by the ratio of the sheath flow to the sample flow, depending on the known initial number concentration of the measurement sample or on the basis of a first measurement cycle.

11. The method according to claim 1, wherein, for the size determination of very wide polydisperse samples, no exchange of measurement chambers or changes of the flowcell have to be carried out.

12. The method according to at least one of claim 1, wherein beam stops are successively inserted or displaced, or ring-shaped detectors that each cover an angle range are used, or different apertures are introduced into circular sectors, the different scattered light signals being measured and evaluated separately.

13. The method according to at least one of claim 1wherein, by using ring-shaped detectors or different apertures in circular sectors, the repeat measurements described in the examples in other angular ranges are eliminated, which advantageously reduces the experimental effort and increases the measurement accuracy through the simultaneous measurement of different angle ranges for the same particle.

14. The method according to at least one of claim 1, wherein, for extinction applications, the ratio of the light intensity of the light source in the cuvette to an extinction signal is improved by hydrodynamic focusing and by masking out the areas illuminated by the primary radiation in the image space that are adjacent to the hydrodynamically focused particles, in order to detect smaller particles.

15. The method according to at least one of claim 1, wherein, for extinction applications, a pinhole aperture inserted after the objective and having the diameter of the laser primary beam after the objective eliminates a large part of the forward scattering that would also strike the receiver, thereby extending the measurement range to smaller particles and allowing more precise particle size calculations.

16. A device for determining the properties of microscale and sub-microscale particles in measurement samples by multiparametric detection of scattered light and extinction signals, the device comprising:
at least one laser for generating at least one laser beam;
at least one optical input module for shaping the laser beam and forming a focus geometry;
a flow measuring cell with hydrodynamic focusing, in which forward scattered light radiation and sideward scattered light radiation are generated by the laser beam;
optical output modules in the forward scattered light beam and optical output modules in the sideward scattered light beam;
semi-transparent mirrors;
cameras; and
photomultipliers using which scattered light measurements are carried out for a different number of aperture and reception angles, and intensities of the forward scattered light beam and of the sideward scattered light beam are determined from the determined scattered light using evaluation algorithms.

17. A method comprising using a device according to claim 16 for the analysis of multiple features of individual particles or the classification or identification of particle fractions in the industrial and academic fields, such as W/O or O/W emulsions, aerosols, slurries for wafer polishing, ink and pigment suspensions, samples of cellular and sub-cellular particles (including cells, viruses, bacteria) of biological origin or for applications, e.g. the design of nanoparticles, quantification of the stability of dispersions, investigations into the dissolution, agglomeration and flocculation behaviour of disperse phases, quantification of the progress of dispersions, quantification of the progress of dispersions.
